(19) United States
(12) Patent Application Publication
(10) Pub. No.: US 2008/0091554 A1
(43) Pub. Date: Apr. 17, 2008

(54) Method of selling software via network

(76) Inventors: Ing-Kai Huang, Hsinchu City (TW); Daryn Huang, Claremont, CA (US)

Correspondence Address: HDSL, 4331 STEVENS BATTLE LANE, FAIRFAX, VA, 22033, US

(21) Appl. No.: 11/548,744

(22) Filed: Oct. 12, 2006

(51) Int. Cl. G06Q 30/00

(52) U.S. Cl. 705/26

(57) ABSTRACT

In a method of selling software via network, a software provider pre-stores an executable program in a portable storage device; the executable program is executed automatically at a purchaser's personal computer connected to the storage device; the personal computer is connected to a software provider's server via a network after the executable program is executed; the input of required data (such as the software/hardware conditions of the personal computer and the purchaser's data) is required; and after the data is inputted server, the software purchased by the purchaser is transmitted to the purchaser's personal computer via a network for a direct installation of the software.

### BACKGROUND OF THE INVENTION

1. Field of the Invention

The present invention relates to selling software, and more particularly to a method of selling software via a network.

2. Description of Prior Art

There are two main traditional methods of selling software. In one of the methods, a software provider stores a software into an optical disk first, and packs the optical disk together with an installation guide and a user's guide into a carton, and a distributor sells the software to a purchaser, and the purchaser installs the purchased software into a computer. In another method, a purchaser downloads a software directly from a software provider's server to the purchaser's computer by an online trading mechanism via a network, and then the purchaser installs the software. However, both software selling methods still have existing problems.

To prevent software purchasers from making or distributing unauthorized copies, the software providers generally set at least one exclusive password for purchasers to enter before starting the installation of the software, and one of the necessary features of the password is its difficulty to remember and the password is usually composed of a long string of alphanumeric characters or even with combined upper and lower cases. Once if the password is lost, the software cannot be installed, which causes tremendous inconvenience to consumers. The password of a package software is generally printed in a written form and placed in a carton, but such arrangement still bears the risk of the software being copied by unauthorized people, and thus causing damages and inconvenience to the software providers, distributors and purchasers.

Regardless of using an optical disk or downloading a software by purchasers, the software is a software installer. Theoretically, any copied software can be used for the installation to other computers, and thus bearing the risk of being copied by unauthorized people. Even with an anti-copy technology or a password mechanism, such anti-copy measures still cannot prevent cracks and duplications by others. Although these measures can increase the level of difficulty of duplicating or distributing the software, the measures cannot thoroughly prevent unauthorized duplications and distributions.

Further, the software is installed by purchasers, but not every purchaser is familiar with computers and there are many options to be selected for the installation. The installation always involves the issues of the operating system of the computer and the hardware and software environments of the computer as well as the issues of virus and anti-virus software. After a software is installed, there may be problems on its applications or system compatibility. Based on the aforementioned reasons, a software purchaser usually has problems at the installation stage and cannot complete the installation, or has problems at the first time of use and cannot use the software at all. All these cause much inconvenience to software purchasers, and software providers have to consume lots of human resources to set up a customer service department to solve different technical problems and service customers.

### SUMMARY OF THE INVENTION

In view of the foregoing shortcomings of the prior art, the inventor of the present invention based on years of experience in the related industry to conduct experiments and modifications, and finally invented a method of selling software in accordance with the present invention.

Therefore, the present invention is to provide a method of selling software that conducts a full service for software purchasers by a specific service personnel, and the software is downloaded directly from a software provider's server to a software purchaser's computer via a network, and the service personnel directly installs the downloaded software to the computer and teaches purchasers how to use the software, so as to prevent any possible problems on the software installation and application.

The present invention is to provide a method of selling software, wherein the download of a software requires a specific service personnel to load a specific executable program by a portable storage device which is connected to a computer to be installed with the software. After the software is installed, such software will become useless and no longer can provide the installation function, so as to prevent possible unauthorized duplications and distributions without setting a password.

### BRIEF DESCRIPTION OF DRAWINGS

The features of the invention believed to be novel are set forth with particularity in the appended claims. The invention itself however may be best understood by reference to the following detailed description of the invention, which describes certain exemplary embodiments of the invention, taken in conjunction with the accompanying drawings in which:

FIG. 1 is a schematic view of a method of selling software in accordance with the present invention; and

FIG. 2 is a flow chart of a method of selling software in accordance with the present invention.

### DETAILED DESCRIPTION OF THE INVENTION

The technical characteristics, features and advantages of the present invention will become apparent in the following detailed description of the preferred embodiments with reference to the accompanying drawings. However, the drawings are provided for reference and illustration only and are not intended for limiting the scope of the invention.

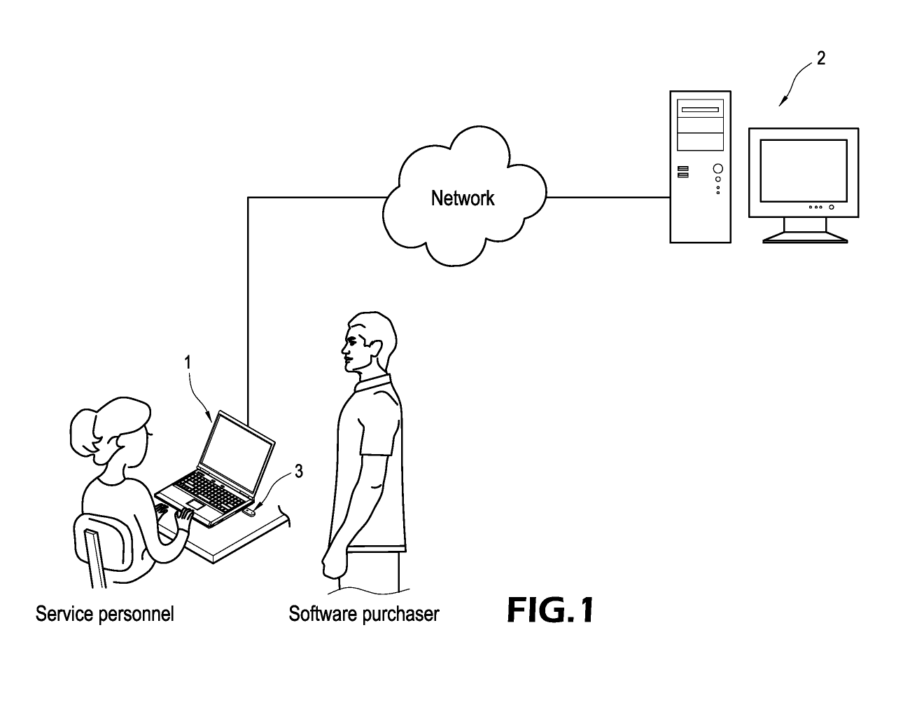

Referring to FIG. 1 for a schematic view of a method of selling software in accordance with the present invention, a software purchaser shows his/her desire of purchasing a software to a software provider or its distributor via network, telephone, or personally at a shop, and the software provider or distributor will send a trained service personnel to meet the software purchaser, and the meeting place could be a place for operating a computer or where the software will be installed (such as a desktop computer at the software purchaser's home or office or a notebook computer at any place). When the service personnel meets the software purchaser, the service personnel carries a portable storage device 3, preferably a flash memory storage device (or known as a flash stick), and of course the portable storage device also could be a write-once optical disk (such as CD-R or DVD-R) or a portable hard disk. The portable storage device 3 has an interface, preferably a USB interface, connected to the computer, and the portable storage device 3 has a memory space divided into two parts: a read only area for storing fixed data that cannot be erased or altered such as the identity data of the service personnel holding the portable storage device 3 and a write area for storing a floating data that can be erased or altered, such as a customer's data and a product data, etc.

In the read only area of a portable storage device 3 carried by a service personnel, an executable program is pre-stored, such that if the portable storage device 3 is connected to a software purchaser's computer 1, the executable program will be executed at the computer 1 and will request the service personnel to input a specific data such as a service personnel's identity code, a software purchaser's data, a desired purchasing software data and a payment data, etc. The data are inputted by the service personnel. If all of the data are inputted correctly, then a network connection will be established between the computer 31 and the software provider's server 2, and the server 2 will download the desired purchasing software to the computer 1 via a network, and such transaction data is stored as a transaction record, and the software provider can inquire the transaction record to know about the time and location of a service personnel who sells the software to which purchaser. Since the service personnel's identity data is stored in the read only area of the portable storage device 3, and the inputted identity code is compared with the stored identity data, therefore any unauthorized people other than the service personnel cannot complete the transaction, even if such person obtains the portable storage device 3.

After the software is downloaded to a software purchaser's computer 1, a service personnel can directly execute the installation at the computer 1. If there is any installation problem, the service personnel can solve the problem immediately at the site. After the software is installed, the service personnel shows the main using procedure and method to the software purchaser, so as to complete the sale of the software. Since the purchaser has not handled the installation procedure personally and the software installer will be deleted after the software is installed and the purchaser can obtain the installed software, therefore the installation program cannot be duplicated or distributed. Such arrangement does not require a password or an anti-copy mechanism to eliminate the risk of unauthorized duplications.

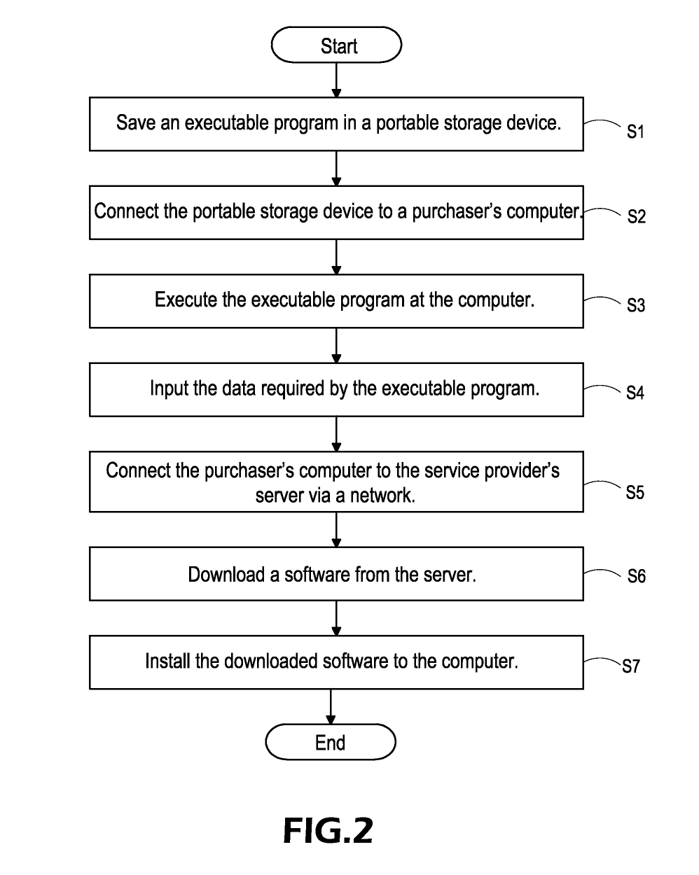

Referring to FIG. 2 for a flow chart of a method of selling software, an executable program is stored in a portable storage device 3 (S1); the portable storage device 3 is connected to a purchaser's computer 1 to be installed with the software (S2); an executable program is executed at the computer 1 (S3); and the executed executable program requests an input of required data (S4); after the required data is inputted correctly, the executable program establishes a network connection between the purchaser's computer 1 and the software provider's server 2 (S5); the desired purchasing software is downloaded from the server 2 (S6); and the downloaded software is installed to the computer (S7).

The present invention is illustrated with reference to the preferred embodiment and not intended to limit the patent scope of the present invention. Various substitutions and modifications have suggested in the foregoing description, and other will occur to those of ordinary skill in the art. Therefore, all such substitutions and modifications are intended to be embraced within the scope of the invention as defined in the appended claims.

What is claimed is:

1. A method of selling software, comprising the steps of:
(a) storing an executable program into a portable storage device;
(b) connecting the portable storage device to a purchaser's computer;
(c) executing the executable program on the computer;
(d) inputting required data to the executable program;
(e) creating a network connection between the computer and a software provider's server;
(f) downloading a desired purchasing software from the server;
(g) installing the downloaded software to the computer.

2. The method of selling software of claim 1, wherein the portable storage device is a flash memory storage device.

3. The method of selling software of claim 1, wherein the portable storage device has a memory space divided into a read only area and a write area.

4. The method of selling software of claim 3, wherein the read only area of the portable storage device stores an identity data.

5. The method of selling software of claim 1, wherein the inputted data of step (d) includes at least one selected from the collection of an identity code, a software purchaser's data, a desired purchasing software data and a payment data.

6. The method of selling software of claim 1, wherein the downloaded software of step (f) is a software installer.

7. The method of selling software of claim 6, further comprising a step (h) that deletes the software installer after the step (g) is finished.
